(19) United States
(12) Patent Application Publication
(10) Pub. No.: US 2014/0072894 A1
(43) Pub. Date: Mar. 13, 2014

(54) COOLANT CYCLE FOR A FUEL CELL SYSTEM AND METHOD FOR OPERATING A COOLANT CYCLE

(71) Applicants: Mario Mittmann, Owen (DE); Wolfgang Schwienbacher, Dettingen (DE); Markus Mohr, Weilheim (DE); Tom Haastert, Stuttgart (DE); Joris De Jong, Esslingen a.N. (DE); Matthias Wuest, Stuttgart (DE); Hans-Juergen Mau, Sindelfingen (DE); Bianca Limbaecher, Koengen (DE)

(72) Inventors: Mario Mittmann, Owen (DE); Wolfgang Schwienbacher, Dettingen (DE); Markus Mohr, Weilheim (DE); Tom Haastert, Stuttgart (DE); Joris De Jong, Esslingen a.N. (DE); Matthias Wuest, Stuttgart (DE); Hans-Juergen Mau, Sindelfingen (DE); Bianca Limbaecher, Koengen (DE)

(73) Assignee: DAIMLER AG, Stuttgart (DE)

(21) Appl. No.: 14/114,943

(22) PCT Filed: Apr. 11, 2012
(86) PCT No.: PCT/EP2012/001572

§ 371 Date: Oct. 31, 2013

(30) Foreign Application Priority Data
May 6, 2011 (DE) 10 2011 100 711.7

(51) Int. Cl. H01M 8/04

(52) U.S. Cl. CPC H01M 8/04723
USPC 429/434

(57) ABSTRACT

A coolant circuit (1) for a fuel cell system of a vehicle. Coolant (10) is able to flow through a coolant line (3) in the cooling operation, and an ion exchanger module (4) can be fluidically coupled with the coolant line (3). The coolant circuit (1) has at least one closing element (8), formed to close the coolant line (3). The closing of the same via the at least one closing element (8) is effected by an uncoupling of the ion exchanger module (4) from the at least one coolant line (3). Furthermore, the invention relates to a method to operate the coolant circuit (1).

The invention relates to a coolant circuit for a fuel cell system, which comprises at least one coolant line, through which coolant is able to flow in the cooling operation. An ion exchanger module can be fluidically coupled with the at least one coolant line. Furthermore, the coolant circuit comprises at least one closing element, formed to close the at least one coolant line. The coolant circuit is, in particular, provided for a fuel cell system of a vehicle. Furthermore, the invention relates to a method to operate a coolant circuit for a fuel cell system.

The coolant used in the coolant circuit of a fuel cell system must be highly purified, in particular with regard to metal ions. Metal ions in particular can contaminate the polymer electrolyte membrane (PEM) or the catalyst layers of fuel cells. In order to ensure the purity of the coolant, an ion exchanger module, for example in the form of an ion exchanger cartridge, is integrated into the coolant circuit of the fuel cell system. The ion exchange capacity of the ion exchanger material present in the cartridge diminishes over time, such that the cartridge must be exchanged regularly. During the exchange of the ion exchanger module, the risk exists, however, that impurities reach the coolant.

DE 11 2007 001 478 T5 describes an ion exchanger for a fuel cell vehicle. The ion exchanger is arranged in a chamber surrounded by a shock absorber and a mud guard of the vehicle. If an ion exchanger application of the ion exchanger is removed and replaced, then the coolant lines fixed in the vehicle are closed with sealing plugs. Thus the coolant is prevented from leaking or foreign bodies are prevented from reaching the coolant.

Furthermore, it is known from prior art to introduce ion exchanger material into the coolant circuit in loose form or in a small bag or pouch in place of an ion exchanger cartridge. If a pouch with ion exchanger resin is introduced, for example, into a coolant expansion tank, then, as a rule, this does not lead to the desired ion exchanger effect, as the coolant preferably flows around the pouch and does not flow through the pouch. In the case of ion exchanger material poured into the coolant circuit in loose form, this material can be uncontrollably displaced in the coolant circuit and can lead to blockages, sedimentation or mechanical damage. In this way a coolant pump can be damaged or coolant channels inside the fuel cells can be blocked. This can lead to disturbances in the function of the fuel cell system and entail costly repairs or maintenance. Thus, an ion exchanger module, which can be fluidically coupled with the coolant lines of the coolant circuit, is useful with regard to the functionability of the fuel cell system.

The object of the present invention is to create a coolant circuit of the type named at the beginning, as well as a method to operate such a coolant circuit, one or both of which reduces the risk of contamination of the coolant in a particularly simple way.

This object is solved by a coolant circuit with the features of claim 1 as well as by a method with the features of claim 10. Advantageous embodiments with expedient developments of the invention are specified in the dependant claims.

The coolant circuit according to the invention for a fuel cell system, in particular of a vehicle, comprises at least one coolant line, through which coolant is able to flow in the cooling operation. An ion exchanger module can be—at least indirectly—fluidically coupled with the at least one coolant line. Furthermore, the coolant circuit comprises at least one closing element, by means of which the at least one coolant line is able to be closed. Here, it is effected that the at least one coolant line is closed by means of the at least one closing element through an uncoupling of the ion exchanger module from the at least one coolant line. In other words, the closing of the at least one coolant line occurs automatically, in that the ion exchanger module is fluidically uncoupled from the at least one coolant line.

Through such an automatic closing mechanism, it is ensured that the closing element closes the allocated coolant line in the case of a replacement of the ion exchanger module, already indirectly after the removal thereof by a component of the coolant circuit—so with the interruption of the fluidic coupling. Then no impurities can enter the coolant line. The risk of contamination is herein reduced in a particularly simple way, as sealing plugs do not need to be laboriously inserted into the cooling lines, but rather the closing is effected simply by the removal of the ion exchanger modules.

The closing of the coolant line is also not able to be forgotten, as is possible in the case of the provision of separate sealing plugs as closing elements. Forgetting a sealing plug can lead to a leakage of the coolant and consequently to an overheating of the fuel cells or to an emergency shut down during of the operation of the fuel cell system. In the case of a fuel cell system provided to drive a vehicle, the vehicle can then not longer move along. This can be prevented presently by the closing element that automatically closes the cooling line.

In the case of an ion exchanger module, which is not properly installed in the coolant circuit, the coolant lines are thus presently closed, and it is no longer damaging if a new, unused ion exchanger module is not installed directly after the removal of the exhausted ion exchanger module in the coolant circuit.

The coolant line, which can be closed by means of the closing element, can in particular be a coolant flow line and/or a coolant return line.

In an advantageous embodiment of the invention, the at least one closing element is also formed to uncover the at least one coolant line, wherein the uncovering or opening of the coolant line can be effected by the—at least indirect—fluidic coupling of the ion exchanger module with the same. Thus, an automatic opening mechanism is also provided, such that not only the closing but also the opening of the coolant line is particularly effortless. To uncover the coolant line, the ion exchanger module simply needs to be installed. Furthermore, in the case of the dismantled ion exchanger module, damage to the fuel cells by the impurities, which have entered the coolant, is avoidable.

It is particularly simple if the at least one closing element is formed as a non-return valve. Such a valve can easily be pushed open by the ion exchanger module during installation of the same, and thus opened. The pushing open of the non-return valve can in particular be effected by the corresponding formation of an inlet opening and/or of an outlet opening of the ion exchanger module, so, for example, by a protruding inlet nozzle or outlet nozzle. The non-return valve closes automatically if the ion exchanger module is removed from the coolant circuit.

Additionally or alternatively, a closing flap can be provided to close the at least one coolant line, which can be pushed downwards, upwards or away by the ion exchanger module during installation and can thus be opened. Such a closing flap can—for example with regard to the coolant level in a coolant expansion tank—be arranged horizontally or vertically. Here, an inlet opening and/or an outlet opening of the ion exchanger module can effect the opening of the closing flap during the fluidic coupling of the ion exchanger module with the at least one coolant line. The reliable and cost-effective closing flap closes automatically if the ion exchanger module is dismantled. An axis of rotation of the closing flap can, in particular—for example as in the case of a sealing butterfly valve—be arranged in the centre, wherein the closing and/or uncovering of the coolant line can be effected by rotating an axle arranged in the central axis.

Additionally or alternatively, at least one turntable can be provided as a closing element, said turntable having at least one opening. By rotating the turntable, the opening, for example in the form of a continuous bore hole, of a channel, of a plurality of holes, of openings arranged in a fan shape or similar, can be overlapped with the cross section of the coolant line, which is able to be flowed through, in order to uncover the coolant line. If the turntable is rotated further, then this effects a closing of the coolant line. Also, the turntable is formed in such a way that it is rotated into an initial closing position during dismantling of the ion exchanger module. The turntable can be arranged horizontally or vertically with respect to an axial direction of the coolant line or to the coolant level, in the same way as the closing flap.

Preferably, the turntable is already rotated by the installation of the ion exchanger module, such that coolant leaving or entering the coolant line is able to flow through its at least one opening. Here, an inlet opening and/or an outlet opening of the ion exchanger module can also effect the rotating of the turntable. Additionally or alternatively, carrier elements can be provided on the ion exchanger module, and the turntable can be rotated by means of the ion exchanger module.

If a narrow side of the turntable is arranged perpendicularly to the axial direction of the coolant line, the turntable can, in particular, be rotatable around its central point or eccentrically in order to effect the closing or uncovering of the coolant line. The turntable can also be formed in the manner of a serrated increment circle, which is then rotatable by means of a serrated actuating element. The turntable can also comprise a basic body and a cloak-like covering element, which is rotatable relative to this basic body, or a sleeve or similar parts that are firmly connected to one another, wherein the closing or uncovering of the coolant line is effected by rotating the covering element. The covering element can also be formed immovably and the basic body enclosed by the covering element can be formed rotatably.

A further possibility consists in providing a circle segment as a closing element, which is rotated in order to close or uncover the coolant line. Similarly, this can be effected by rotating a hollow body, which in particular can be formed cylindrically. If an opening, provided in such a cylindrical or tubular hollow body, is overlapped by the cross section of the coolant line, which is able to be flowed through, then the coolant line is uncovered.

The at least one closing element can also be formed as a bolt and/or a slider, which can effect the closing and/or uncovering of the coolant line. The bolt or slider can itself have at least one opening, for example a bore hole, a channel, a plurality of holes, openings arranged in a fan shape or similar, or it can be pushed away from the coolant line to be closed, in order to uncover this. The slider or bolt can also be arranged horizontally or vertically in the coolant circuit. The installation of the ion exchanger module in the coolant circuit preferably effects a rotation or shifting of the bolt or slider, in order to ensure that coolant line can be flowed through. During the removal of the ion exchanger module, the bolt or slider move back into an initial closing position. During the installation of the ion exchanger module, the inlet opening and/or outlet opening thereof can effect the movement of the bolt or slider. The slider can, in particular, be formed in the manner of a mechanical shutter, for example in the manner of an iris shutter for a camera, or in the manner of a fan, which in particular has blades, or a telescope mechanism can be provided.

For a particularly secure closing of the coolant line, each coolant line can also be provided with a plurality of the named closing elements. The different, presently described closing elements can also be used in combination.

It has been shown to be further advantageous if at least one actuating element to actuate the at least one closing element is arranged on the ion exchanger module. Then the closing element does not need to be actuated by means of the inlet opening or the outlet opening of the ion exchanger module, but rather the actuating element, which is particularly suited for this purpose, can be used. The actuating element can thus be designed particularly robustly with regard to operational safety and susceptibility to closing. Such an actuating element can in particular be formed as a mandrel or a cone or a cam or a wedge or as a sphere or as a tappet or a gear rack. Actuating elements of this sort in combination with one another can also effect the actuation of the at least one closing element or several closing elements.

The closing element can be arranged partially outside components of the coolant circuit and the actuating element can be arranged completely outside components of the coolant circuit, through which coolant flows in the cooling operation. For example, the actuating element can be fixed on a fixing flange of the ion exchanger module, said actuating element then actuating the closing element during installation of the ion exchanger module in the coolant circuit. Then the actuating element does not come into contact with the coolant.

It is preferable, however, that at least one closing element is arranged completely in a position, which is wettable by the coolant in the cooling operation and that at least one actuating element is arranged at least partially in a position, which is wettable by the coolant in the cooling operation. Then the closing element and the actuating element are particularly well protected.

According to a further advantageous embodiment of the invention, the at least one closing element can comprise an electrical and/or electromechanical actuator, which is able to be actuated by closing an electrical contact. Here, the closing of the electrical contract by the uncoupling of the ion exchanger module from the at least one coolant line is able to be actuated. Additionally or alternatively to a mechanical opening or closing mechanism, an electrical or electromechanical closing mechanism or opening mechanism can be used.

The closing of the electrical contact can additionally or alternatively be effected by the fluidic coupling of the ion exchanger module with the at least one coolant line. Then the installation of the ion exchanger module in the coolant circuit leads to the electrical contact being closed and thus the actuator being actuated, wherein the actuator then effects an uncovering of the coolant line. Simple and functionally reliable electrical shut-off valves, throttle valves or similar can be used as electrical or electromechanical actuators. The electrical contact can, in particular, be formed as a finger contact.

Additionally or alternatively to the electrical contact, a contactless, controllable switch can be provided, the closing of which is actuated by the actuator. Such a contactless switch can, for example, be formed as a magnetic switch, in particular as a magnetic passive switch and/or it can comprise a chip, as is used in an RFID system (Radio Frequency Identification).

In particular, when providing a RFID system, which comprises a transponder and a reader, not only the actuation of the actuator can be effected by the control of the contactless switch, but also it can be additionally ensured that only the provided ion exchanger module can be installed in the coolant circuit, in order to avoid problems and risks through the installation of unsuitable ion exchanger modules. By providing actuators, which are able to be actuated by the closing of the electrical contact or of the switch that is able to be controlled contactlessly, wearing can be kept particularly low in comparison to mechanical opening or closing mechanisms.

It has been shown to be further advantageous if a switch is able to be actuated by the uncoupling of the ion exchanger module from the coolant line and/or by the fluidic coupling of these components, by means of which at least one functional unit of the coolant circuit is controllable. Such a switch can be formed as an electromechanical switch, for example as a micro-contact switch or as a magnetic switch, or can comprise an electrical contact, in particular a finger contact. Thus, the electrical energy flow to the functional units can be influenced—directly or via a control device—by the deinstallation or installation of the ion exchanger module.

The functional unit can comprise an electrical coolant pump or an electrical thermostat, such that the coolant flow can be decreased or interrupted during the uncoupling of the ion exchanger module from the coolant line. In this way, the coupling or uncoupling of the ion exchanger module simultaneously effects an activation or deactivation of at least one functional unit of the coolant circuit. If the actuation of the switch by the uncoupling of the ion exchanger module from the coolant line is triggered, the deinstallation of the ion exchanger module can ensure an interruption of the coolant flow, without a further operational step needing to be carried out for this.

The actuation of the switch by the installation or deinstallation of the ion exchanger module can additionally or alternatively produce a signal. If the signal is transmitted to a control device of the fuel cell system, then this can ensure that a starting up of the fuel cell stack is prevented if the ion exchanger module is removed, in order to, for example, prevent any damage to the fuel cell stack.

Additionally or alternatively the signal can be able to be communicated to an operator, for example in that an optical and/or audible warning message is emitted in the arrangement of the fuel cell system in the vehicle, for example via an instrument panel. Then the operator is informed that a start-up of the fuel cell system should be stopped due to the present lack of ion exchanger module. The signal can also generate error codes, for example for diagnostic purposes. Such error codes can be found during troubleshooting or a test or by carrying out a test, in particular a short test.

In a further advantageous embodiment of the invention, a mechanical and/or electronic coding is provided, by means of which the fluidic coupling of an ion exchanger module that is not suited to the coolant circuit with the at least one coolant line is able to be interrupted. It is thus ensured that only a suitable ion exchanger module can be installed in the coolant circuit, as the installation of an unsuitable ion exchanger module could possibly cause damage to the fuel cell stack. A pairing of a key bit and a key opening or keyhole can be provided as a mechanical coding, or fixing or carrier elements or similar can be arranged in such a way that only the installation of the suitable ion exchanger module in the coolant circuit is possible. The electronic coding can occur in particular via an RFID system.

The ion exchanger module can be able to be introduced into the coolant circuit by plugging in and/or screwing in and/or locking into place and/or rotating the same. Here, it is particularly advantageous if reaching an installation position is accompanied by an optical and/or audible and/or perceptible response. Thus, for example, a defined end stop can be provided, which specifies when the provided installation position is reached. Also, the weight of the ion exchanger cartridge can ensure that this has reached the desired installation position during installation. If the ion exchanger module is rotated, in order to bring it into the installation position, then a defined rotation, for example of a quarter or a half of a complete rotation, can be provided.

In the method according to the invention to operate a coolant circuit for a fuel cell system, at least one coolant line, which coolant is able to flow through in the cooling operation, is closed by means of at least one closing element. Here, the closing of the at least one coolant line is effected by the ion exchanger module being uncoupled from the at least one coolant line. In other words, the—at least indirect—fluidic coupling of the ion exchanger module with the coolant line is removed. Due to the automatic closing of the coolant line effected in this way, the risk of contamination of the coolant during the exchange of the ion exchanger module is decreased.

The advantages described for the coolant circuit according to the invention and preferred embodiments are also valid for the method according to the invention.

The features and combinations of features named above in the description, as well as the features and combinations of features named below in the description of the figures and/or shown below in the figures alone are not only able to be used in the respective specified combination, but also in other combinations or on their own, without exceeding the scope of the invention.

Further advantages, features and details of the invention arise from the claims, the description below of preferred embodiments, as well as by means of the drawings, in which identical or functionally identical elements are provided with identical reference numerals. Herein are shown:

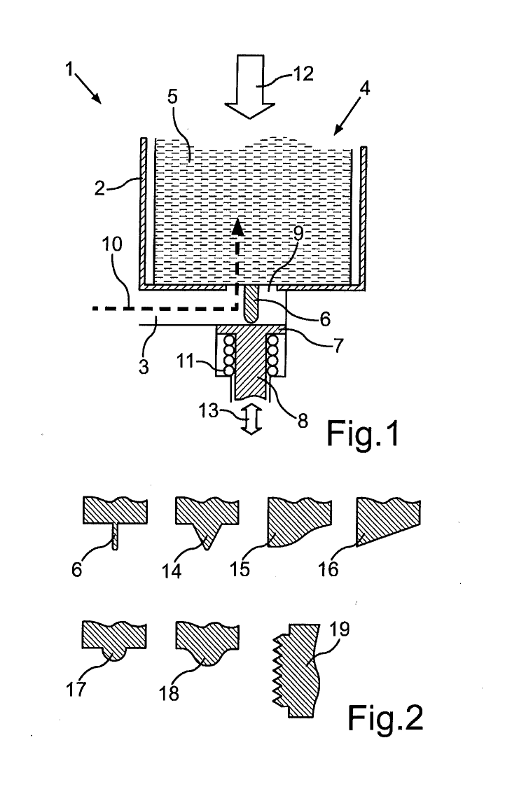

FIG. 1 a sectional and schematic view of a coolant circuit for a fuel cell system of a vehicle, wherein an ion exchanger cartridge is used in a coolant container and hereby a non-return valve, arranged in a coolant inflow to the coolant container, is opened;

FIG. 2 a schematic view of possible forms of actuating elements to open and close the non-return valve according to FIG. 1 or a closing element of this sort;

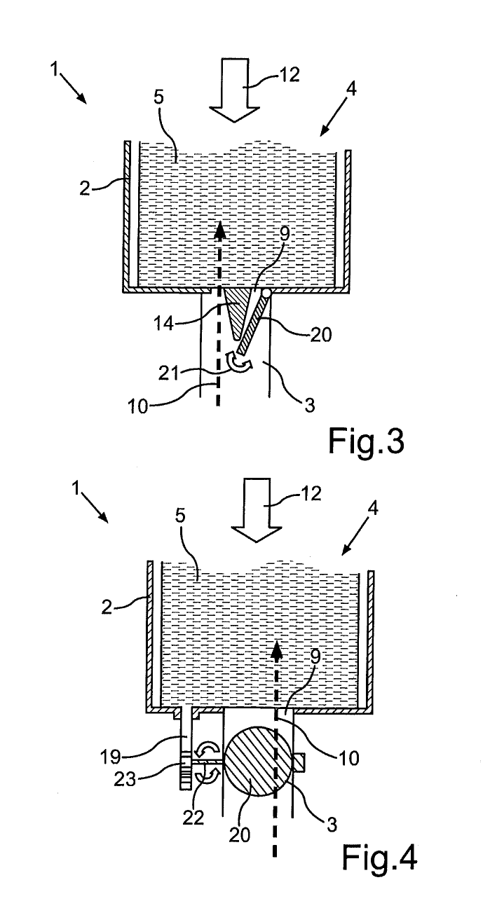

FIG. 3 a sectional view of a coolant circuit with a closing flap arranged in the coolant inflow to the coolant container, said closing flap being opened by a cone arranged on the ion exchanger cartridge;

FIG. 4 a sectional view of a coolant circuit with a closing flap formed in the manner of a throttle valve, which is actuated by a gear rack, wherein the gear rack is arranged on the ion exchanger cartridge and the closing flap is arranged in the coolant inflow to the coolant container;

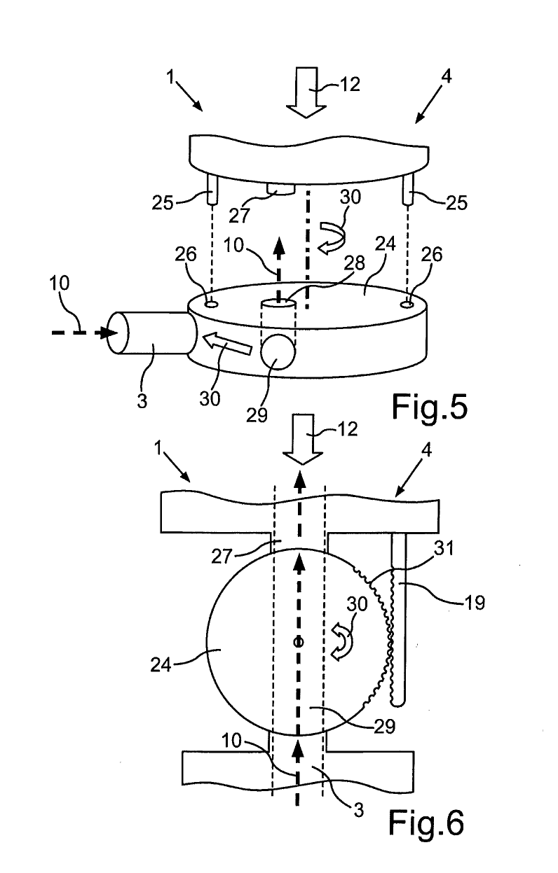

FIG. 5 a sectional view of a coolant circuit with a turntable, which is able to be rotated in an inserted ion exchanger cartridge and the channel of which can be overlapped with the coolant inflow;

FIG. 6 a sectional view of a coolant circuit with a turntable as a closing element for the coolant inflow, wherein the turntable has a central channel and is actuated by means of a gear rack;

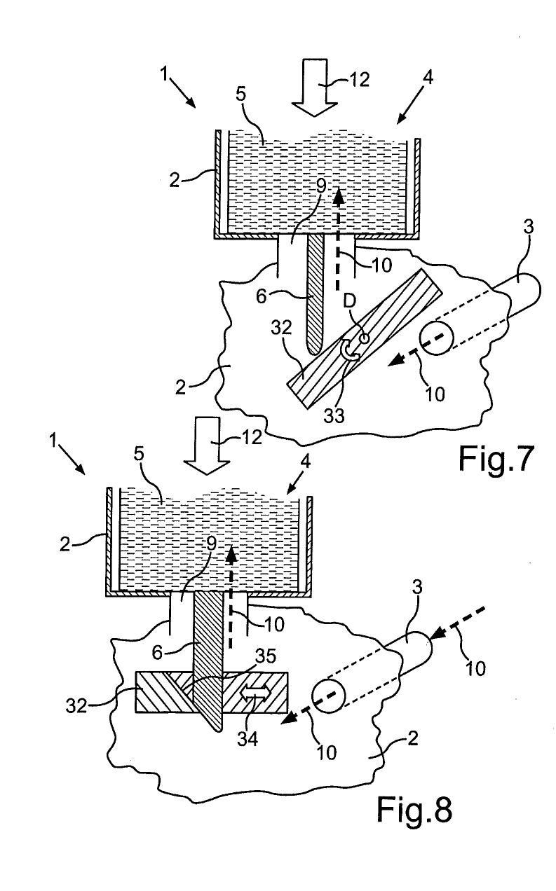

FIG. 7 a sectional view of a coolant circuit with an ion exchanger cartridge, on which a mandrel is arranged as an actuating element, which rotates a bolt in order to uncover the coolant inflow to the coolant container;

FIG. 8 a sectional view of a coolant circuit with an ion exchanger cartridge, on which a wedge shaped mandrel is arranged as an actuating element, said mandrel shifting a bolt linearly in order to release the coolant inflow to the coolant container;

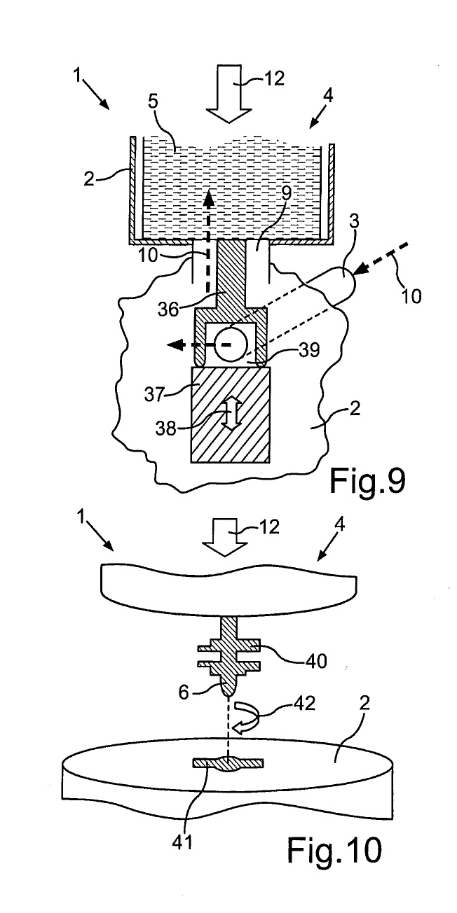

FIG. 9 a sectional view of a coolant circuit with a slider, which is able to be shifted in the direction of installation of the ion exchanger cartridge, said slider being moved by the insertion of the ion exchanger cartridge in the coolant container into an open position and thus releasing the coolant inflow to the coolant container; and

FIG. 10 a sectional view of a coolant circuit with a mechanical coding arranged on the ion exchanger cartridge.

In FIG. 1, a coolant container 2 and a coolant line 3, which is presently formed as a coolant inflow or a coolant flow line, are shown by a coolant circuit 1 for a fuel cell system of a vehicle. An ion exchanger cartridge 4 is inserted into the coolant container 2, said ion exchanger cartridge containing an ion exchanger material 5. In FIG. 1 a mandrel 6 is shown on an underside of the ion exchanger cartridge 4 as an actuating element, which pushes away a valve plate 7 of a non-return valve 8 from an inlet opening 9, via which the coolant, which flows through the coolant line 3, enters the ion exchanger cartridge 4 and thus the coolant container 2. The coolant, which is illustrated in FIG. 1 by a flow arrow 10, presently flows through the ion exchanger material 5 in the coolant container 2 from bottom to top.

In the depicted example, the valve plate 7 of the non-return valve 8 is under the initial tension of a spring 11, which ensures that the non-return valve 8 automatically closes the coolant line 3 as soon as the ion exchanger cartridge 4 is removed from the coolant container 2. The direction of insertion of the ion exchanger cartridge 4 into the coolant container 2 is illustrated in FIG. 1 by a directional arrow 12. The installation of the ion exchanger cartridge 4 in the coolant container 2 leads to the coolant line 3 being opened or uncovered by the mandrel 6, whilst the deinstallation of the ion exchanger cartridge 4 leads to an automatic closing of the coolant line 3. Thus, contamination of the coolant during an exchange of the ion exchanger cartridge 4 is avoidable. A direction of movement of the non-return valve 8 during closing or uncovering of the coolant line 3 is illustrated in FIG. 1 by a double arrow 13.

The actuating element formed in FIG. 1 as a mandrel 6 is shown on a lower wall of the ion exchanger cartridge 4; however such an actuating element can also be arranged on a side wall of the same. The actuating element shown presently as an example in the centre of the ion exchanger cartridge 4 can also be arranged with displacement towards an edge of the same. Furthermore, an inlet nozzle or outlet nozzle of the ion exchanger cartridge 4 can be formed as an actuating element, such that a separate mandrel 6 does not need to be provided.

FIG. 2 shows schematically possible actuating elements for the opening and closing mechanism, such as the non-return valve 8 shown, for example, in FIG. 1. Thus, a cone 14, a cam 15, a wedge 16, a sphere 16 or half sphere 17, a tappet 18 or a gear rack 19 can be provided in order to effect the opening or closing of the closing element which closes the coolant line 3.

For example, in the embodiment of the coolant circuit 1 shown in FIG. 3, the cone 14 is provided on the ion exchanger cartridge 4, which opens a closing element in the form of a closing flap 20, if the ion exchanger cartridge 4 is inserted into the coolant container 2. A rotating movement of the closing flap 20 is illustrated by a directional arrow 21. In the present example, the closing flap 20 moves automatically into its closing position, which closes the coolant line 3, due to a resetting spring (not shown), if the ion exchanger cartridge 4 is removed from the coolant container 2. In the place of the resetting spring, in principle hydraulic or electrical resetting elements are also considered.

In the embodiment of the coolant circuit 1 shown in FIG. 1 and FIG. 3, both the closing elements and the actuating elements are arranged in parts of the coolant circuit 1 through which coolant is able to flow. In the embodiment according to FIG. 4, the closing flap 20 arranged in the coolant line 3 is rotatable around its central axis in the manner of a throttle valve, wherein an axle 22 provided to rotate the closing flap 20 is arranged outside the coolant line 3. The axle 22 has a gear wheel 23, which is rotated by means of a gear rack 19, arranged on the ion exchanger cartridge 4. The gear rack 19 here lies outside the coolant line 3 and outside the coolant container 2. In the present example, a resetting spring (not shown) ensures the resetting of the closing flap 20 into its closing position, which closes the coolant line 3 if the ion exchanger cartridge 4 is deinstalled.

In the case of the coolant circuit 1 according to FIG. 5, a turntable 24 is provided as a closing element. During installation of the ion exchanger cartridge 4 in the coolant circuit 1, carrier pins 25 or fixing elements provided hereon are introduced into the corresponding openings 26, which are provided on the turntable 24. The corresponding installation direction of the ion exchanger cartridge 4 is specified by the directional arrow 12. At the same time, an inlet nozzle 27 of the ion exchanger cartridge 4 is introduced into an opening 28, which is formed as an outlet of a channel 29 provided in the turntable 24.

The channel 29 can be overlapped by the coolant line 3 by rotating the turntable 24 in a rotation direction specified in FIG. 5 by arrows 30, such that the coolant can flow from the coolant line 3 via the channel 29 into the inlet nozzle 27 of the ion exchanger cartridge 4. The turntable 24 has a resetting device (not shown), which moves into the closing position shown in FIG. 5 if the ion exchanger cartridge 4 is removed from the turntable 24.

Ion exchanger cartridge 4 and turntable 24 can thus be formed such that they form the complementary parts of a joint, such that they can be joined or assembled together in a detachable way. It is particularly advantageous if both joining parts, i.e. ion exchanger cartridge 4 and turntable 24, are formed such that they result in a bayonet joint. Both joining parts can then be coupled by setting, i.e. by an insertion and rotating movement. Ion exchanger cartridge 4 and turntable 24 can thus be fluidically coupled in a particularly quick and secure manner, and also later uncoupled.

In the embodiment of the coolant circuit 1 shown in FIG. 6, the installation of the ion exchanger cartridge 4 effects the rotation of the turntable 24, in which a gear rack 19, arranged on the ion exchanger cartridge 4, engages with a toothing system, which is provided on the outer peripheral side of the turntable 24. Thus a channel 29, embodied in the centre of the turntable 24 and in the manner of a bore hole, is aligned such that it couples the inlet nozzles 27 on one side and the coolant line 3 on the other fluidically to one another. During the removal of the ion exchanger cartridge 4, the turntable 24 rotates in the opposite direction. Thus the coolant line 3 is then closed by the turntable 24. The rotation directions of the turntable 24 are illustrated in FIG. 6 by an arrow 30.

In the embodiment of the coolant circuit 1 shown in FIG. 7, a bolt 32 which is able to be rotated into its initial position or closing position by means of a resetting spring is provided as a closing element. The bolt 32 is rotatable around an axis of rotation D, as is illustrated in FIG. 7 by a directional arrow 33. The rotation of the bolt 32 is effected by a mandrel 6, which is arranged on a lower wall of the ion exchanger cartridge 4, in that the ion exchanger cartridge 4 is inserted into the coolant container 2. The bolt 32 is arranged inside the coolant container 2, into which the coolant line 3 flows. If the ion exchanger cartridge 4 is removed, then the bolt 32 closes the coolant line 3 due to the force of a resetting spring (not shown). In place of the resetting spring, in principle hydraulic or electrical resetting elements are also considered.

In the embodiment of the coolant circuit 1 shown in FIG. 8, the bolt 32 is not able to be rotated, but is arranged so that it is able to be shifted linearly, as is illustrated by a directional arrow 34. During the insertion of the ion exchanger cartridge 4 into the coolant container 2, the wedge-shaped mandrel 6 is fed into an incline 35 of the bolt 32. The mandrel 6 that presently has a corresponding incline accordingly effects a shifting of the bolt 32 away from the inlet opening of the coolant line 3 into the coolant container 2. Here, a resetting spring or similar resetting device is also provided in order to move the bolt 32 back into its closing position that closes the coolant line 3, if the ion exchanger cartridge 4 is removed from the coolant container 2.

In the embodiment of the coolant circuit 1 shown in FIG. 9, an actuating element 36 moves a slider 37 downwards, if the ion exchanger cartridge 4 is inserted into the coolant container 2 corresponding to the directional arrow 12. The slider 37 has a resetting device, which moves it into a closing position in the case of a deinstalled ion exchanger cartridge 4, in which closing position the coolant line 3 which flows into the coolant container 2 is closed by the slider 37. A corresponding movement direction of the slider 37 is illustrated in FIG. 9 by a directional arrow 38.

The actuating element 36 has a recess 39, which uncovers the inlet opening of the coolant line 3 into the coolant container 2 in the case of an ion exchanger cartridge 4 being inserted into the coolant container 2.

An installation direction is also specified in FIG. 10 in the case of the guided insertion of the ion exchanger cartridge 4 into the coolant container 2 by the directional arrow 12, which points downwards. A key bit 40 is shown schematically on a mandrel 6 of the ion exchanger cartridge 4, introduced into the coolant container 2 during installation of the ion exchanger cartridge 4 in the coolant circuit 1, as an example of a mechanical coding. A key opening 41 is provided accordingly in the region of the coolant container 2, into which the key bit 40 can be inserted. Subsequently the fixing of the ion exchanger cartridge 4 on the coolant container 2 can be secured and/or the coolant line 3 can be uncovered by the rotating of the ion exchanger cartridge 4 relative to the coolant container 2. The uncovering or opening of the coolant line 3 can also be effected by the insertion of the mandrel 6, which has the key bit 40, into the coolant container 2. A rotation direction during the rotation of the ion exchanger cartridge 4, and with it the key bit 40, is specified in FIG. 10 by an arrow 42.

The coding ensures that only an ion exchanger cartridge 4 can be installed and used in the coolant circuit 1. Additionally, it is thus ensured that only the ion exchanger cartridge 4 that is provided for and therefore corresponds to the coolant circuit 1 can be properly inserted.

In place of the mechanical opening and closing mechanisms described presently by means of the figures, a closing or uncovering of the coolant line 3, effected by closing an electrical contact, can also be provided. Here, an electrical or electromechanical actuator, for example an electrical throttle valve or an electrical shut-off valve, can be used.

Additionally or alternatively to the mechanical coding, an electronic coding can also be provided, for example in the form of an RFID system, which ensures that only the suitable ion exchanger cartridge 4 can be installed in the coolant circuit 1.

The closing elements, shown presently as an example, to close and uncover the coolant line 3, can have a plurality of geometric shapes and can be formed, for example as a sphere, cone, cylinder, plate or similar. The surfaces of these closing elements, which effect the closing, can have different shapes such as that of a rectangle, a square, a circle or similar. The same applies for sealing elements, which can be provided on the closing elements.

In terms of materials for the closing elements, preferred are those which are compatible with the deionised coolants of the coolant circuit 1, in particular comprising distilled water. Thus, plastic, rubber, stainless steel, fibre reinforced plastic, in particular glass fibre reinforced plastic or similar can be used as a material. The presently named shapes and materials can also be provided for the actuating elements.

Whilst, in the figures, the closing elements are presently shown to be arranged in immovable components of the coolant circuit 1, for example in the coolant container 2, in alternative embodiments closing elements of this kind can additionally be provided on the ion exchanger cartridge 4. A respective actuating element can then be provided on sides of the components of the coolant circuit 1 which are immovable during the exchange of the ion exchanger cartridge 4. Then such a closing element in the removed ion exchanger cartridge 4 prevents an undesired leakage of the ion exchanger material 5 from the same.

1. A coolant circuit for a fuel cell system having at least one coolant line (3), through which coolant (10) is able to flow in the cooling operation, and with which an ion exchanger module (4) can be fluidically coupled, wherein the coolant circuit (1) comprises at least one closing element (8, 20, 24, 32, 37), formed to close the at least one coolant line (3), wherein the closing of the at least one coolant line (3) by the at least one closing element (8, 20, 24, 32, 37) is effected by an uncoupling of the ion exchanger module (4) from the at least one coolant line (3).

2. A coolant circuit according to claim 1, wherein the at least one closing element (8, 20, 24, 32, 37) is formed to uncover the at least one coolant line (3), wherein the uncovering can be effected through the fluidic coupling of the ion exchanger module (4) with the at least one coolant line (3).

3. A coolant circuit according to claim 1, wherein the at least one closing element comprises
a non-return valve (8) and/or
a closing flap (20) and/or
a turntable (24) and/or
a circle segment and/or
an in particular cylindrical hollow body and/or
a bolt (32) and/or
a slider (37).

4. A coolant circuit according to claim 1, comprising at least one actuating element to actuate the at least one closing element (8, 20, 24, 32, 37), which is arranged on the ion exchanger module (4).

5. A coolant circuit according to claim 1, wherein the at least one closing element (8, 20, 24, 32, 37) is arranged completely in a position of the coolant circuit (1), which is wettable by the coolant (10) in the cooling operation and/or the at least one actuating element (6, 14, 15, 16, 17, 18, 19) is arranged at least partially in a position of the coolant circuit (1), which is wettable by the coolant (10) in the cooling operation.

6. A coolant circuit according to claim 1, wherein the at least one closing element (8, 20, 24, 32, 37) comprises an electrical or electromechanical actuator, which is able to be actuated by closing
an electrical contact and/or
a contactless controllable switch, and
wherein the closing can be effected by
the uncoupling of the ion exchanger module (4) from the at least one coolant line (3) and/or
the fluidic coupling of the ion exchanger module (4) with the at least one coolant line (3).

7. A coolant circuit according to claim 1, wherein a switch is able to be actuated by the uncoupling of the ion exchanger module (4) from the at least one coolant line (3) and/or by the fluidic coupling of the ion exchanger module (4) with the at least on coolant line (3), via which at least one functioning unit of the coolant circuit (1) is controllable and/or a signal is able to be produced.

8. A coolant circuit according to claim 1, further comprising a mechanical and/or electronic coding (40, 41), via which the fluidic coupling of an ion exchanger module (4) which is unsuited to the coolant circuit (1) with the at least one coolant line (3) is able to be prevented.

9. A coolant circuit according to claim 1, wherein the ion exchanger module (4) is able to be introduced into the coolant circuit (1) by plugging in and/or screwing in and/or locking in place and/or rotating.

10. A method to operate a coolant circuit (1) for a fuel cell system, in which at least one coolant line (3), which coolant is able to flow through in the cooling operation, is closed by means of at least one closing element (8, 20, 24, 32, 37), wherein the closing of the at least one coolant line (3) is effected by an uncoupling of the ion exchanger module (4) from at least one coolant line (3).

11. The coolant circuit according to claim 1, wherein said coolant circuit is a component of a vehicle fuel cell system.

12. The coolant circuit according to claim 4, wherein the at least one actuating element is a mandrel (6) or a cone (14) or a cam (15) or a wedge (16) or a sphere (17) or a tappet (18) or a gear rack (19).

13. The coolant circuit according to claim 7, wherein the signal is able to be communicated to an operator and/or is able to be transmitted to a control device of the fuel cell system.

14. The method according to claim 10, wherein said coolant circuit is a component of a vehicle fuel cell system.
